(19) United States
(12) Patent Application Publication
(10) Pub. No.: US 2018/0321806 A1
(43) Pub. Date: Nov. 8, 2018

(54) ARRANGING USER REPRESENTATIONS ACCORDING TO A PRIORITY OF USERS THAT ARE CONCURRENTLY GENERATING INSTANT MESSAGE CONTENT

(71) Applicant: MICROSOFT TECHNOLOGY LICENSING, LLC, Redmond, WA (US)

(72) Inventors: Sergio Eduardo RODRIGUEZ VIRGEN, Bothell, WA (US); Casey James BAKER, Seattle, WA (US)

(21) Appl. No.: 15/586,901

(22) Filed: May 4, 2017

(51) Int. Cl. G06F 3/0484; H04L 12/58; H04L 12/18; G06F 3/01

(52) U.S. Cl. CPC G06F 3/0484; G06F 3/013; H04L 12/1813; H04L 51/043

(57) ABSTRACT

An instant messaging (IM) system facilitates an IM session between numerous client devices and arranges user representations associated with multiple users to communicate a priority of the users that are concurrently generating message content to other participants of an IM session. During an IM session, users may view a graphical arrangement of user representations and, based thereon, consciously and/or subconsciously perceive the priority between users that are concurrently generating message content. The priority may be based on an order in which the users began generating message content or a status of the users with respect to each other. Based on the perceived priority, users may appropriately respond to social cues similar to those that would be perceptible if the IM session were instead a real-life conversation.

### BACKGROUND

Instant Messaging (IM) systems enable substantially real-time transmission of message content and, in many situations, reduce barriers to effective communication and collaboration. For example, an IM system may enable multiple users to seamlessly communicate within an IM session in a conversational manner without physically coming together. Some existing systems allow users to communicate remotely by passing written messages back and forth in real-time. Effective conversational communication is dependent on participants being able to perceive and appropriately respond to social cues. For example, once a participant begins to respond by typing a message, others may refrain from contributing until the participant has finished responding. As another example, when an important individual begins to actively contribute to a conversation others may pause their own contributions as a sign of respect.

Conventional IM systems have numerous limitations with respect to communicating social cues to multiple users that are conversationally communicating in an IM session. For example, when multiple users are simultaneously generating message content for an IM session, conventional IM systems fail to indicate exactly who is actively responding. Furthermore, these systems fail to indicate any sort of priority or status between multiple users that are simultaneously typing message content. For example, the participants of the IM session lack the ability to perceive an order in which the multiple users began typing. Furthermore, the participants of the IM session lack the ability to perceive when certain important individuals such as, for example, business executives begin to actively contribute within an IM session.

As such, there is a need for an improved IM system that addresses these issues. It is with respect to these and other considerations that the disclosure made herein is presented.

### SUMMARY

The techniques disclosed herein provide for the arrangement of user representations according to a priority between multiple users that are concurrently generating instant message (IM) content. In some embodiments, a system can provide an arrangement of user representations that indicates an order in which multiple users began providing an input, such as typing a message. In some embodiments, among other feature disclosed herein, a system can provide an arrangement of user representations based on an organizational status to bring emphasis to important individuals such as, for example, business executives who are actively contributing to an IM session.

Generally described, techniques disclosed herein enable a system to facilitate an IM session between numerous client computing devices (also referred to herein as “client devices”) and to arrange user representations associated with multiple users that are simultaneously or concurrently providing some type of input action that causes the generation of IM content. The input action may include activities such as typing, receiving a voice input, receiving a gesture input, or receiving any other type of user input suitable for generating IM content, also referred to herein as “message content.” Ultimately, the arrangement of the user representations may provide the IM session participants with certain social cues that are imperceptible when using conventional IM systems. For example, when multiple users begin to concurrently type in an IM session, the system can cause client devices to display user representations corresponding to each of these multiple users as they begin typing. In some configurations, the system may determine a graphical arrangement for the user representations to indicate a priority between these multiple users that are contemporaneously or concurrently typing based on an order in which the users began typing, or are otherwise generating message content (e.g. by dictating message content), or indicating a status of the users with respect to each other.

As used herein, the term “graphical arrangement” refers generally to any spatial arrangement of one or more individual graphical elements such as, for example, a graphical representation of a user. Exemplary graphical arrangements include, but are not limited to, a graphical element being arranged adjacent to one or more other graphical elements, a graphical element being at least partially superimposed in front of or behind one or more other graphical elements, a graphical element being rendered within a particular section of another graphical element (e.g. a user representation being rendered within a particular predefined area of a substantially circular user representation grid as described herein).

As used herein, the term “user representation” refers generally to any graphical representation that has been stored in association with a particular user account for the purpose of representing a particular user corresponding to the particular user account. Exemplary user representations include, but are not limited to, a photograph of the particular user, an avatar embodiment of the particular user (e.g. a cartoon graphic resembling or/or not resembling the particular user), and/or any other icon or figure suitable for graphically representing the particular user (e.g. an image of an automobile or an inanimate object). The message content that can be generated by a user can also include text data, image data, video data, or any other data format suitable for communicating information between users of a computer system. Thus, an input action can include typing, drawing, capturing or storing or selecting from storage an image. An input signal can comprise any signal type (e.g. electrical and/or optical) or data format indicating an input action.

As used herein, the term “priority” used in the context of a priority associated with individual users (or user accounts or identities thereof) may generally refer to the state of a particular user being superior to another user in terms of some objectively measurable quality. Exemplary objectively measurable qualities include, but are not limited to, a particular user being temporally superior due to having begun to generate message content prior to another user, a particular user holding a superior position within an organization than another user, and/or a particular user having a higher contribution level in an IM session than another user.

During an IM session, users may view a graphical arrangement of user representations and, based thereon, consciously and/or subconsciously perceive a priority between a corresponding group of other users that are contemporaneously or concurrently generating message content. Based on the perceived priority, users may appropriately respond to social cues similar to those that would be perceptible if the IM session were instead a real-life conversation. For example, in a scenario where users “A” through “C” are all simultaneously typing in an IM session and where participants can tell from the graphical arrangement of the corresponding user representations that user “A” was the first to begin typing, user “A” having temporal priority may cue other users in the IM session (including user “B” and user “C”) to pause contributions to allow user “A” to finish responding. Alternatively, the other users may determine that the conversation between users “A” through “C” is not important to them and, therefore, does not warrant diverting attention from their current task(s). In contrast, if these users were not able to tell that the active conversation was between users “A” through “C,” their curiosity may have unnecessarily drawn their attention into the active IM session. As another example, in a scenario where users “A” and “B” are both simultaneously typing but then their businesses Chief Executive Officer (CEO) begins to type in the same IM session, the graphical arrangement may emphasize a user representation of the CEO as a high priority contributor and, based thereon, user “A” and user “B” may be socially-cued to stop typing and wait for the CEO's contribution.

In some embodiments, the system may be configured to facilitate an IM session by communicating IM data between a plurality of client devices. The system may generate the IM data based upon user input data that is received from individual ones of the plurality of client devices. For example, the IM data may include message content that is sent from a client device to the system and then relayed by the system to other client devices within the IM data. During the IM session, the system may receive user input signals from multiple client devices indicating that message content is being simultaneously generated through multiple user accounts. For example, receiving user input signals from multiple client devices may indicate that multiple users are simultaneously typing message content into a user input element of a graphical user interface on their respective client devices. Based on the user input signals, the system may cause one or more client devices associated with the IM session to display user representations associated with those user accounts through which the user input signals indicate that message content is being generated.

In some embodiments, the system may be configured to dynamically change graphical arrangements of user representations as individual users begin and/or stop generating message content. For example, consider a scenario where during an IM session the system receives user input signal “A” which indicates that message content is being generated at client device “A” through user account “A.” Based on user input signal “A,” the system may cause client devices other than client device “A” to render user representation “A” (corresponding to user account “A”) to indicate to other IM session participants that user “A” is generating message content. For example, user representation “A” may be displayed in association with a typing activity indicator to inform the other IM session participants that user “A” is typing (and therefore may potentially transmit in the near future) a message into a user input element associated with the IM session. Subsequently, the system may receive user input signal “B” indicating that message content is being generated at client device “B” through user account “B.” Ultimately, based on the combination of user input signals “A” and “B,” the system may cause other client devices (i.e. devices other than client devices “A” and “B”) to render user representation “A” in addition to user representation “B” (corresponding to user account “B”) to indicate to the other IM session participants that both of user “A” and user “B” are contemporaneously or concurrently generating message content.

In some embodiments, the system may be configured to determine graphical arrangements of one or more user representations with respect to one or more other user representations based on an order in which respective user input signals were initially received. For example, continuing with the scenario of the immediately previous paragraph, the system may determine that user “A” has priority over user “B” due to user input signal “A” being received prior to user input signal “B.” Then, based on the determined priority, the system may determine a graphical arrangement of user representation “A” with respect to user representation “B.” For example, the system may determine a location of where to render user representation “A” in relation to a location of user representation “B.” In some configurations, the system may also dynamically determine a size of user representation “A” with respect to user representation “B” based on an order of the input activity or other data, such as a priority associated with a user, etc.

In some embodiments, the determined graphical arrangement can be designed to visually indicate to the other users which of users “A” or “B” has priority over the other, e.g. whom started typing first. In some embodiments, the graphical arrangements of the one or more user representations may include a predetermined dominant participant area to which a particular user may be assigned based on a priority over one or more other users. For example, in a scenario where the priority is determined exclusively on a “first-to-type” basis and where user “A” began to type (or otherwise generate message content) prior to user “B,” the system may assign user “A” to a predetermined dominant participant area to communicate to the other IM session participants that user “A” has priority over user “B” even though they are now both contemporaneously or concurrently generating message content. In some embodiments, in the event that a user that is currently assigned to the predetermined dominant participant area stops generating message content for at least a threshold time, the system may re-determine the priority and assign a different user that is continuing to generate message content to the predetermined dominant participant area. In various embodiments, the threshold time may be one second, three seconds, five seconds, or any other amount of time that is suitable to ensure that the respective user has actually stopped generating content rather than merely slowing down or temporarily pausing content generation.

In some embodiments, as different users begin to generate message content and/or stop generating message content, the system may animate transitions between graphical arrangements of different user representations. For example, continuing with the scenario where user “B” begins to type when user “A” is already typing, the system may cause the other IM session participants' client devices to animate a transition between an initial graphical arrangement that includes only user representation “A” to a subsequent graphical arrangement that includes both the user representation “A” and user representation “B.” Then, in the event that user “A” transmits her message and/or stops typing for at least the threshold time, the system may cause another animated transition to animate user “A” out of the display. Stated plainly, user representations may be animated in and out of a graphical user interface associated with the IM session as individual users begin typing and then subsequently stop typing. Furthermore, in some embodiments, the system may be configured to display a generic group-of-users representation when message content is being simultaneously generated through at least a threshold number of user accounts such as, for example, five or more user accounts, eight or more user accounts, or any other suitable threshold number of user accounts. Accordingly, when message content is being generated through at least the predetermined threshold number of user accounts, the system may indicate to the participants of the IM session that many other participants are actively typing without indicating exactly who these other participants are. As used herein, the term “generic group-of-users representation” may refer generally to any graphical image and/or icon suitable to represent a group of users and/or to indicate that a group of users are concurrently generating message content. Exemplary generic group-of-users representations include, but are not limited to, a graphic including a plurality of generic person representations, or a text-based indication that a group of users are concurrently generating message content (e.g. a written message that states “multiple people are typing messages right now” or “14 people are typing messages right now”), or any other suitable graphical indication that multiple users are concurrently typing.

In one illustrative example, the system may arrange individual user representations into a user representation grid having one or more predetermined graphical areas to which a particular user representation may be assigned based on a priority of that particular user representation. For example, an exemplary user representation grid be defined by an outer perimeter that at least partially bounds the user representation grid and one or more predefined graphical areas within the outer perimeter. As a more specific but nonlimiting example, a user representation grid may be defined by a substantially circular outer perimeter having one, two, three, or four predefined graphical areas within the circular outer perimeter when there are one, two, three, or four users concurrently typing, respectively. For example, at a first time the system may initially receive a first user input signal indicating content generation with respect to a first user account. Then, based on the first user input signal, the system may assign a first user representation corresponding to the first user account to a sole predefined graphical area of a user representation grid. Subsequently, at a second time the system may receive a second user input signal indicating content generation with respect to a second user account while content is still being generated with respect to the first user account. Then, based on the combination of the first user input signal and the second user input signal, the system may assign the first user representation corresponding to the first user account to a dominant participant area and a second user representation corresponding to the second user account to a second-most dominant participant area. Subsequently, at a third time the system may receive a third user input signal indicating content generation with respect to a third user account while content is being generated with respect to both the first user account and the second user account. Then, based on the combination of the three user input signals, the system may assign the first user representation to a dominant participant area of a user representation grid having three predefined graphical areas, the second user representation to a second-most dominant participant area of the user representation grid, and so on.

It should be appreciated that the above-described subject matter may be implemented as a computer-controlled apparatus, a computer process, a computing system, or as an article of manufacture such as a computer-readable medium. Among many other benefits, the techniques described herein improve efficiencies with respect to a wide range of computing resources.

For instance, human interaction with a device may be improved during an IM session as the use of the techniques disclosed herein enable a user to actually perceive when multiple IM participants are actively generating message content and also the specific identities of those IM participants while they are generating the message content. In addition, the techniques described herein uniquely arrange user representations of those IM participants to communicate a priority of those IM participants with respect to the others. Once the priority is communicated by the system, the participants of the IM session may be socially-queued to wait for one or more of those IM participants that are actively generating message content to finish and transmit that message content before transmitting message content of their own. Accordingly, it can be appreciated that the techniques described herein tangibly reduce a number of data transmissions and/or a total amount of transmitted data during an IM session. Technical effects other than those mentioned herein can also be realized from implementations of the technologies disclosed herein.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicate similar or identical items.

FIG. 1 is a block diagram of an exemplary instant messaging (IM) system that is suitable for deploying the techniques described herein.

FIG. 2 is a block diagram of an example of the device in the IM system of FIG. 1.

FIG. 3 illustrates aspects of a graphical user interface (GUI) that can be displayed on a client computing device during an IM session in accordance with the techniques described herein. Similar to other GUIs described herein, this example GUI can be displayed on a variety of device types, such as a desktop computer, a laptop computer, a mobile device, or a combination of devices.

FIGS. 4A & 4B illustrate a pictorial flow diagram that shows an illustrative process of dynamically modifying graphical arrangements of user representations based upon user input signals being received from different client computing devices.

FIG. 5 illustrates a pictorial flow diagram that shows an illustrative process of dynamically modifying graphical arrangements of user representations based upon user input signals being received from different client computing devices. FIG. 5 is similar to FIGS. 4A & 4B with the exception that the graphical arrangements shown in FIG. 5 differ from those shown in FIGS. 4A & 4B.

FIGS. 6A and 6B illustrate aspects of GUIs that can be displayed on a client computing device during an IM session in accordance with the techniques described herein.

FIG. 7 is a flowchart illustrating an operation for modifying graphical arrangements of user representations based upon user input signals being received from different client computing devices.

### DETAILED DESCRIPTION

Examples described herein enable a system and/or device to display an arrangement of user representations according to an assigned priority between multiple users that are simultaneously generating instant message (IM) content. Consequently, when multiple participants of an IM session are simultaneously generating message content in association with the IM session, the other participants of the IM session can see exactly which participants are generating message content in addition to the priority between the multiple users that are generating message content. For illustrative purposes, consider the nonlimiting scenario where user “A” begins generating message content, and then user “B” begins generating message content, and then finally user “C” begins generating message content such that all of users “A” through “C” are simultaneously generating message content in association with an IM session. Under these circumstances, the system may display user representations for each of users “A” through “C” in a graphical arrangement that indicates the priority between these users. For example, the graphical arrangement may indicate an order in which users “A” through “C” began typing and/or a status of one or more of users “A” through “C” over the others.

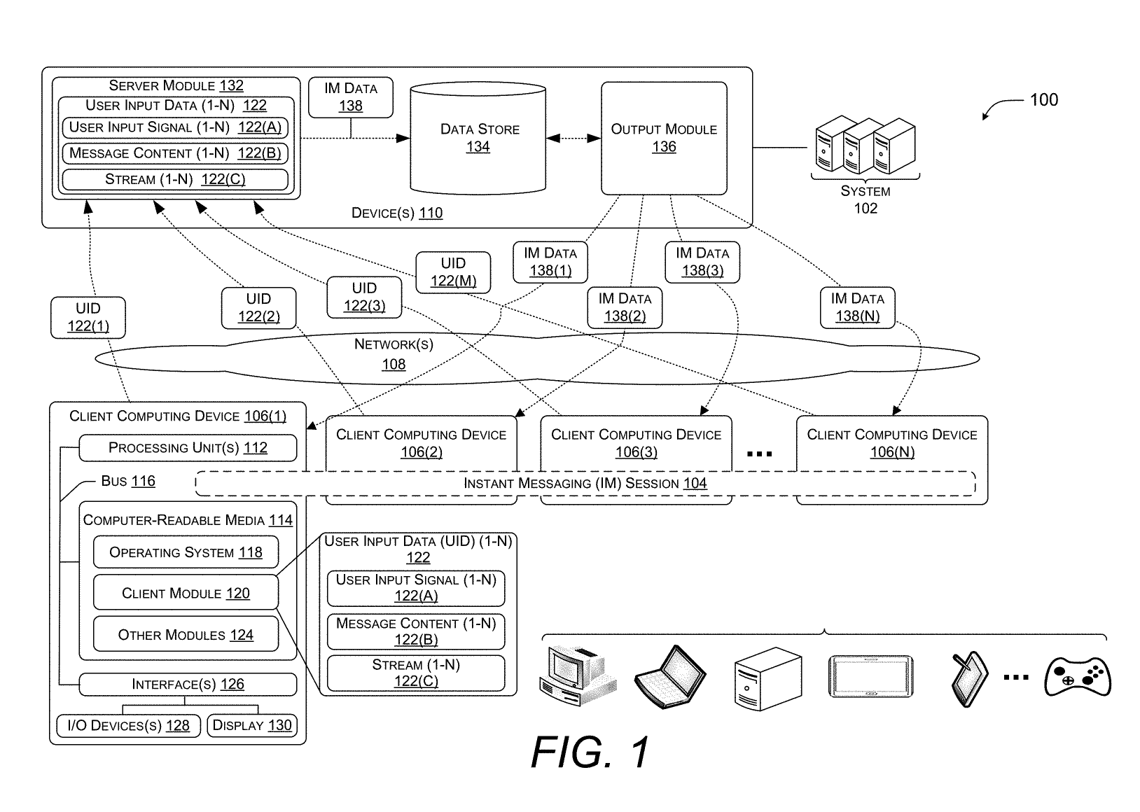

Various examples, implementations, scenarios, and aspects are described below with reference to FIGS. 1 through 7.

FIG. 1 is a diagram illustrating an example environment 100 in which a system 102 can operate to cause message content of an instant messaging (IM) session 104 to be displayed on a client computing device 106 (also referred to herein as a “client device”). In this example, the IM session 104 is an at least substantially real-time IM session that is being implemented between a number of client devices 106(1) through 106(N) (where N is a positive integer number having a value of three or greater). The client devices 106(1) through 106(N) enable users to participate in the IM session 104. In this example, the IM session 104 is hosted, over one or more network(s) 108, by the system 102. That is, the system 102 can provide a service that enables users of the client devices 106(1) through 106(N) to participate in the IM session 104. Consequently, a “participant” in the IM session 104 can comprise a user and/or a client device (e.g., multiple users may be in a conference room participating in an IM session via the use of a single client device), each of which can communicate with other participants. As an alternative, the IM session 104 can be hosted by one of the client devices 106(1) through 106(N) utilizing peer-to-peer technologies.

In examples described herein, client devices 106(1) through 106(N) participating in the IM session 104 are configured to receive and render for display, on a user interface of a display screen, IM data. The IM data can comprise a collection of various instances of user input data such as, for example, message content generated by participants of the IM session at the various client devices and/or user input signals indicating that one or more particular participants are currently generating message content (e.g. that they may potentially choose to transmit to the other participants). In some implementations, an individual instance of user input data can comprise media data associated with an audio and/or video feed (e.g., the message content is not limited to character-based text strings but can also include audio and visual data that capture the appearance and speech of a participant of the IM session). In some implementations, the IM data can comprise media data that includes an avatar of a participant of the IM session along with message content generated by the participant.

In examples described herein, the IM data may be a portion of teleconference data associated with a teleconference session (also referred to herein as “teleconference”) which provisions participants thereof with IM functionality in addition to other types of teleconference functionality (e.g. live audio and/or video streams between participants). Exemplary teleconference data can comprise a collection of various instances, or streams, of live content that are further included in the user input data that is transmitted to the system. For example, an individual stream of live content can comprise media data associated with a video feed (e.g., audio and visual data that capture the appearance and speech of a user participating in the teleconference). Another example of an individual stream of live content can comprise media data that includes an avatar of a participant of the teleconference (through which the IM functionality may be provisioned through and/or in association with) along with audio data that captures the speech of the user. Yet another example of an individual streamof live content can comprise media data that includes a file displayed on a display screen along with audio data that captures the speech of a user.

In examples described herein, the teleconference data can also comprise recorded content. The recorded content can be requested for viewing by a client device. The recorded content can be previous content from a live teleconference that is currently progressing (e.g. a user can rewind a current teleconference), or the recorded content can come from a completed teleconference that previously occurred. In some instances, the recorded content can be configured as an individual stream to be shared as live content in a live teleconference.

In examples described herein, the IM session 104 may be a stand-alone IM session 104 that may supplement a teleconference that includes the various streams of live and/or recorded content within teleconference data to enable a remote meeting to be facilitated between a group of people. For example, the IM session 104 may be facilitated as a subpart of the teleconference to enable participants of the teleconference to communicate by sending instant messages during the teleconference (e.g. so as not to verbally speak up and risk disrupting a flow of the teleconference) and/or after the teleconference (e.g. as follow up to points of discussion or unanswered questions of the teleconference). For illustrative purposes, consider a scenario where, during a teleconference, a participant that is leading the teleconference requests some piece of information (e.g. a sales figure from last quarter) from the other participants and then continues on without waiting for that piece of information to be obtained and communicated to the group. In this scenario, the participant leading the teleconference may post a message in association with the teleconference requesting the piece of information. Then, other participants may respond to this posted message with their own instant message content without disrupting the flow of the teleconference. Furthermore, in some examples, after the teleconference has ended, users may be able to scroll through message content sent during the teleconference and, upon selecting a particular message, the users may be able to listen to recorded content of the teleconference that is temporally close to and/or overlapping with a time during the teleconference when the particular message was sent. For illustrative purposes, consider a scenario where during a teleconference a participant sends a particular message that solely states “Hey Bob, can you look this up?” without any further context. After the teleconference, Bob may scroll through and see this particular message and be unable to respond due to the lack of context. However, upon selecting the message, the portion of the teleconference associated with the question may be replayed to provide the context surrounding the message. For example, the recorded teleconference may reveal that immediately prior to the message being sent, another participant said “Oh, I guess we're missing the 2016 Q4 profit number.”

The system 102 includes device(s) 110. The device(s) 110 and/or other components of the system 102 can include distributed computing resources that communicate with one another and/or with the client devices 106(1) through 106(N) via the one or more network(s) 108. In some examples, the system 102 may be an independent system that is tasked with managing aspects of one or more IM sessions such as IM session 104 as described above. In some examples, the system 102 may be an independent system that is tasked with managing aspects of one or more IM sessions within teleconferences having video and/or audio aspects in addition to IM functionality as also described above. As an example, the system 102 may be managed by entities such as SLACK, WEBEX, GOTOMEETING, GOOGLE HANGOUTS, CISCO, FACEBOOK, MICROSOFT, etc.

Network(s) 108 may include, for example, public networks such as the Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device (e.g. a server-type device) device(s) 110 may include a diverse variety of device types and are not limited to a particular type of device. Device(s) 110 may represent, but are not limited to, server computers, desktop computers, web-server computers, personal computers, mobile computers, laptop computers, tablet computers, or any other sort of computing device.

In various examples, a client device 106 may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client device can include, but is not limited to, a desktop computer, a game console and/or a gaming device, a tablet computer, a personal data assistant (“PDA”), a mobile phone/tablet hybrid, a laptop computer, a telecommunication device, a computer navigation type client device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, a client device 106 may include a combination of the earlier listed examples of the client device such as, for example, desktop computer-type devices or a mobile-type device in combination with a wearable device, etc.

Client devices 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses.

Executable instructions stored on computer-readable media 114 may include, for example, an operating system 118, a client module 120, and other modules 124, programs, or applications that are loadable and executable by processing units(s) 112.

Client devices 106(1) through 106(N) may also include one or more interfaces 126 to enable communications between client devices 106(1) through 106(N) and other networked devices, such as device(s) 110, over network(s) 108. Such interface(s) 126 may include one or more network interface controllers (NICs) or other types of transceiver devices to send and receive communications and/or data over a network. Moreover, client devices 106(1) through 106(N) can include input/output (“I/O”) interfaces that enable communications with input/output devices 128 such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 1 illustrates that client device 106(N) is in some way connected to a display device (e.g., a display screen 130), which can display the IM data in association with the IM session 104 and/or a teleconference as described herein.

In the example environment 100 of FIG. 1, client devices 106(1) through 106(N) may use their respective client modules 120 to connect with one another and/or other external device(s) in order to participate in the IM session 104 (and in some instances to a teleconference as described herein). For instance, a first user may utilize a client device 106(1) to communicate with a second user of another client device 106(2) and also a third client device 106(3). When executing client modules 120, the users may share data, which may cause the client device 106(1) to connect to the system 102 and/or the other client devices 106(2) through 106(N) over the network(s) 108. Users may use the client module 120 of their respective client devices 106 to generate participant profiles, and provide the participant profiles to other client devices and/or to the device(s) 110 of the system 102. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for IM sessions, invite users to participate in IM session, and/or to identify which particular user is associated with a particular user input signal and/or particular message content transmitted into the IM session 104. A participant profile may further include a user representation such as, for example, a photograph of the particular user, an avatar embodiment of the particular user (e.g., a cartoon graphic resembling and/or not resembling the particular user), and/or any other icon or figure suitable for graphically representing the particular user (e.g., an image of an automobile or an inanimate object).

As shown in FIG. 1, the device(s) 110 of the system 102 includes a server module 132, a data store 134, and an output module 136. The server module 132 is configured to receive, from an individual one of the client devices 106(1) through 106(N), user input data 122(1) through 122(M) (where M is a positive integer number equal to two or greater). As illustrated, various instances of the user input data 122 may include one or more user input signals 122(A), one or more instances of message content 122(B), and/or one or more streams 122(C) (as described herein with relation to a teleconference session). As used herein, the term “user input signal” refers generally to any signal that is suitable to indicate that a participant of the IM session 104 is currently generating message content in association with the IM session 104. For example, a user input signal 122(A) may be a constant and/or periodic electronic data signal that is transmitted to the system 102, by a particular client device 106, in response to and while a user is utilizing one or more of the input/output devices 128 to generate message content 122(B) in association with the IM session 104 (e.g., by entering text into a user input element of the IM session). In some examples, a user input signal 122(A) may include a first data signal that indicates that a particular user has commenced generating message content 122(B) and a second data signal (that is subsequent to the first data signal) that indicates that the particular user has ceased generating message content 122(B). As used herein, the term “message content” refers generally to any media content that can be generated in association with the IM session 104 and can be potentially transmitted in the IM session (e.g., the message content need not be transmitted to perform the various techniques disclosed herein). Exemplary media content includes, but is not limited to, text data (e.g., text characters) that has been typed into a user input element (e.g., a data entry field) of a graphical user interface displayed on a client device 106 in association with the IM session 104. In some scenarios, not all the client devices 106 utilized to participate in the IM session 104 provide an instance of user input data 122, and thus, M (the number of instances submitted) may not be equal to N (the number of client devices). For example, a client device may only be a consuming, or a “listening”, device such that it only receives content associated with the IM session 104 but does not provide any content to the other client devices that are participating in the IM session 104. In such a scenario, the number of computing devices 106(N) may be greater than the number of uses of user input data submitted 122(M).

The server module 132 is configured to generate instant message (IM) data 138 based on the user input data 122. In various examples, the server module 132 can select aspects of the user input data 122 that are to be shared with the participating client devices 106(1) through 106(N). The IM data 138 can define aspects of an IM session 104, such as the identities of the participants, message content 122(B) that has been shared with respect to the IM session 104, and/or user input signals 122(A) indicating that one or more particular users are generating message content 122(B). In some examples, the IM data 138 may further include one or more streams 122(C) that a particular user may be sharing with other participants of an IM session 104 and/or a teleconference as described herein. The server module 132 may configure the IM data 138 for the individual client devices 106(1) through 106(N). For example, IM data 138 can be divided into individual instances referenced as 138(1) through 138(N).

Upon generating the IM data 138, the server module 132 may be configured to store the IM data 138 in the data store 134 and/or to pass the IM data 138 to the output module 136. For example, the output module 136 may communicate the IM data instances 138(1) through 138(N) to the client devices 106(1) through 106(N). Specifically, in this example, the output module 136 communicates IM data instance 138(1) to client device 106(1), IM data instance 138(2) to client device 106(2), IM data instance 138(3) to client device 106(3), and IM data instance 138(N) to client device 106(N), respectively.

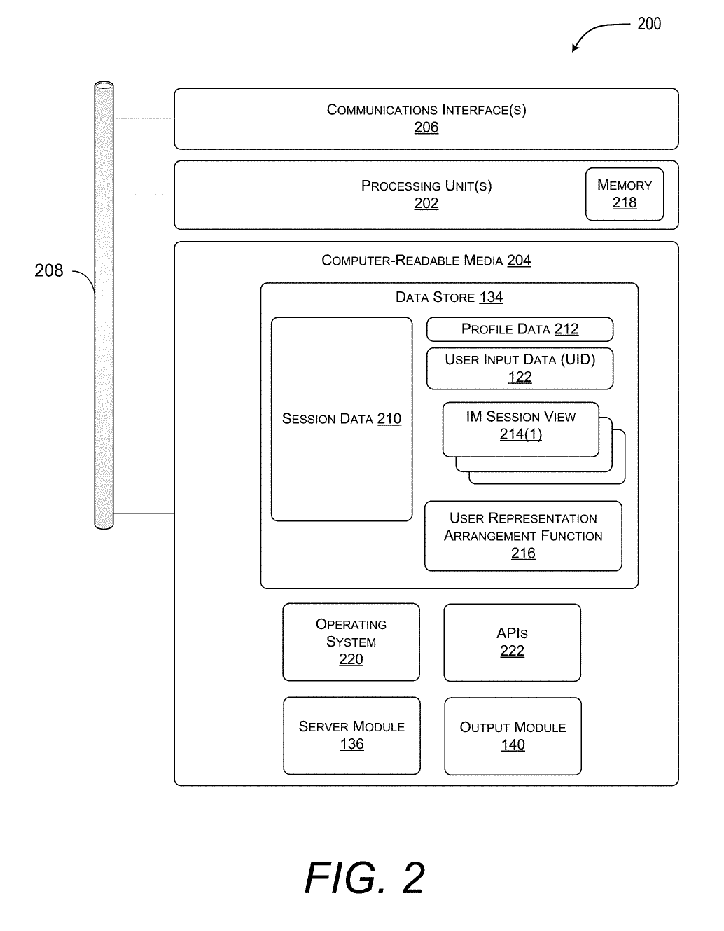

In FIG. 2, a system block diagram is shown illustrating components of an example device 200 configured to provide the IM session 104 between a plurality of devices, such as client devices 106(1) through 106(N), in accordance with an example implementation. The device 200 may represent one of device(s) 110 where the device 200 includes one or more processing unit(s) 202, computer-readable media 204, and communication interface(s) 206. The components of the device 200 are operatively connected, for example, via a bus 208, which may include one or more of a system bus, a data bus, an address bus, a PCI bus, a Mini-PCI bus, and any variety of local, peripheral, and/or independent buses.

As utilized herein, processing unit(s), such as the processing unit(s) 202 and/or processing unit(s) 112, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“AS SPs”), System-on-a-Chip Systems (“SOCs”), Complex Programmable Logic Devices (“CPLDs”), etc.

As utilized herein, computer-readable media, such as computer-readable media 204 and/or computer-readable media 114, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communications media. That is, computer storage media does not include communications media consisting solely of a modulated data signal, a carrier wave, or a propagated signal, per se.

Communication interface(s) 206 may represent, for example, network interface controllers (“NICs”) or other types of transceiver devices to send and receive communications over a network. The communication interfaces 206 are used to facilitate communication over a data network with client devices 106.

In the illustrated example, computer-readable media 204 includes the data store 134. In some examples, the data store 134 includes data storage such as a database, data warehouse, or other type of structured or unstructured data storage. In some examples, the data store 134 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 134 may store data for the operations of processes, applications, components, and/or modules stored in computer-readable media 204 and/or executed by processing unit(s) 202 and/or accelerator(s). For instance, in some examples, the data store 134 may store session data 210 (e.g., IM data 138), profile data 212, and/or other data. The session data 210 may include a total number of participants in the IM session 104, and activity that occurs in the IM session 104 (e.g., behavior, activity of the participants), and/or other data related to when and how the IM session 104 is conducted or hosted. Examples of profile data 212 include, but are not limited to, a participant identity (“ID”), a user representation that corresponds to the participant ID, and other data.

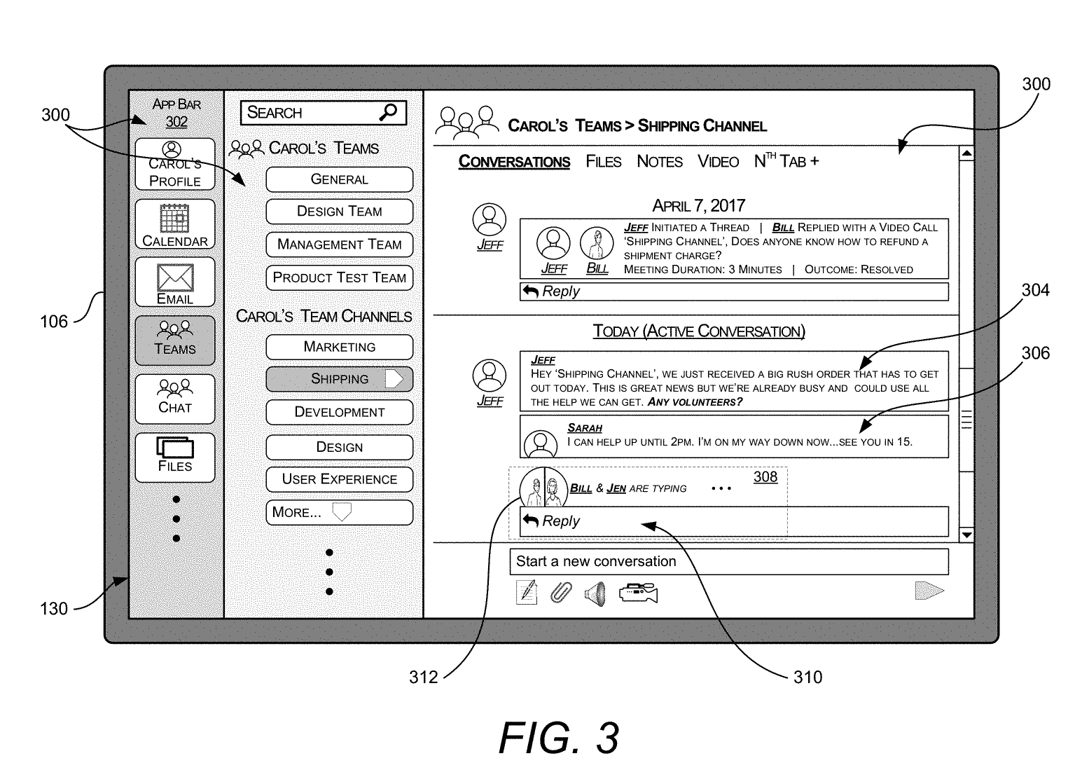

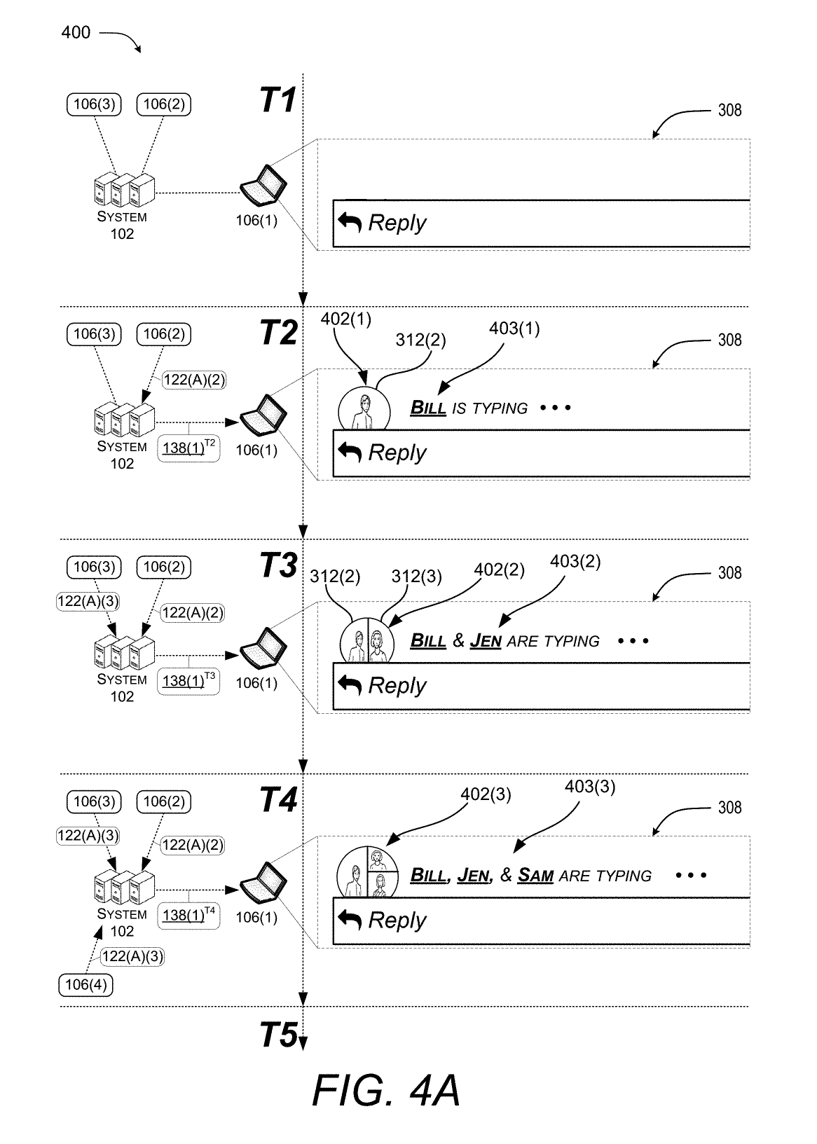

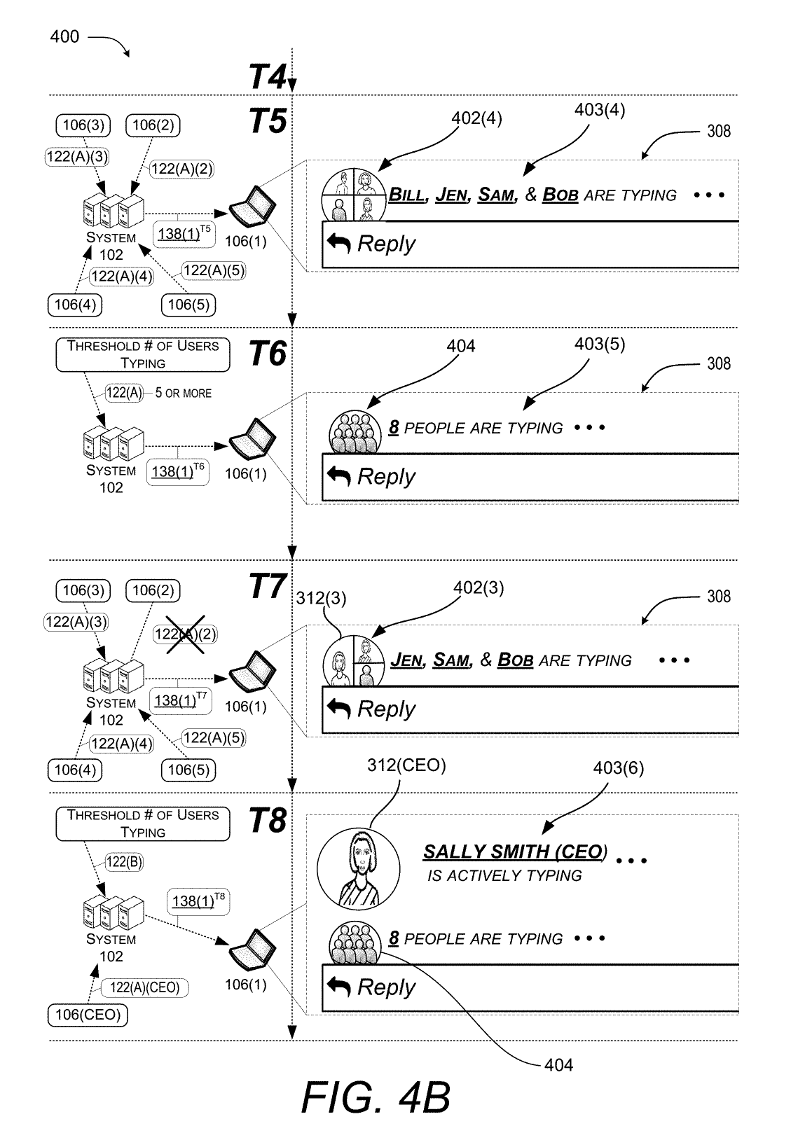

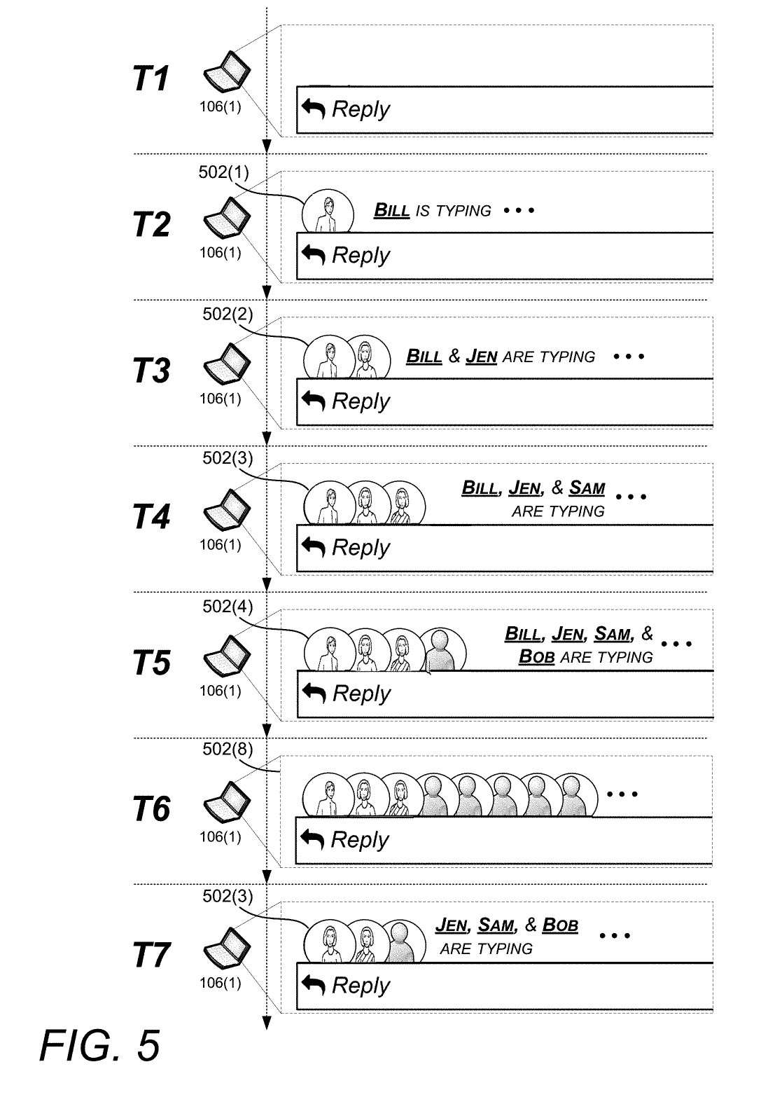

In an example implementation, the data store 134 stores data related to the various views each participant experiences on the display of their respective client device(s) 106 while participating in and/or “listening” in on the IM session 104. As shown in FIG. 2, the data store 134 may include an IM session view 214(1) through 214(N) corresponding to the display of each client device 106(1) through 106(N) participating in the IM session 104. In this manner, the system 102 may support individual control over the view each user experiences during the IM session 104. For example, as described in more detail below with reference to FIGS. 3-7, the system 102 may monitor user input signals 122(A) as they are received from one or more individual client devices 106. Then, based on the user input signals 122(A), the system 102 may cause individual client devices to display user representations corresponding to particular user accounts (e.g., as stored in the profile data 212) during a time period in which those particular users are generating message content 122(B). Furthermore, with particular reference to FIG. 4A through FIG. 5, as particular users begin to type and then subsequently stop typing, the system may dynamically modify the IM session views 214 to controllably arrange user representations based on a priority between users that are concurrently providing an input to create message content, e.g., typing a message.

The data store 134 may store the user input data 122, session data 210, profile data 212, IM session views 214, and a user representation arrangement function 216. Alternately, some or all of the above-referenced data can be stored on separate memories 218 on board one or more processing unit(s) 202 such as a memory on board a CPU-type processor, a GPU-type processor, an FPGA-type accelerator, a DSP-type accelerator, and/or another accelerator. In this example, the computer-readable media 204 also includes an operating system 220 and an application programming interface(s) 222 configured to expose the functionality and the data of the device(s) 110 (e.g., example device 200) to external devices associated with the client devices 106(1) through 106(N). Additionally, the computer-readable media 204 includes one or more modules such as the server module 132 and an output module 136, although the number of illustrated modules is just an example, and the number may vary higher or lower. That is, functionality described herein in association with the illustrated modules may be performed by a fewer number of modules or a larger number of modules on one device or spread across multiple devices.

As described above, when a user begins to generate message content 122(B) in association with the IM session 104 at a particular client device 106, the client module 120 of the particular client device 106 may begin to transmit a user input signal 122(A) to the system 102. Upon receiving the user input signals 122(A), the system 102 may deploy the user representation arrangement function 216 to determine a priority between multiple users that are concurrently generating message content from separate client devices 106. In some implementations, the user representation arrangement function 216 may determine the priority between the multiple users based solely on the order in which they began generating message content 122(B). For example, if three users are concurrently typing, then the first to begin typing will have the highest priority, the second to begin typing will have the second highest priority, and the third (last) to begin typing will be lowest in priority. In some implementations, the user representation arrangement function 216 may determine the priority between the multiple users based on one or more factors other than the order in which the multiple users begin generating message content 122(B). For example, if three users are concurrently typing and are of a similar position level within an organization, then the priority between these users may be determined on a first to begin typing basis whereas a fourth user having a higher position level within the organization than the other users may be bumped to the highest priority spot even if this fourth user was not the first to begin typing. Accordingly, in some implementations, the user representation arrangement function 216 may access organizational hierarchy data such as, for example, an organizational chart defining positions within an organization (e.g. “CEO,” “senior project manager,” “entry-level engineer,” etc.), reporting structures (i.e. who reports to whom), etc. In some implementations, based on the determined priority the user representation arrangement function 216 may then be deployed by the system 102 to determine a graphical arrangement for user representations corresponding to the multiple users that are concurrently generating message content from separate client devices 106.

FIG. 3 illustrates aspects of a graphical user interface (GUI) 300 that can be displayed on a display 130 of a client device 106 during an IM session 104 in accordance with an example implementation of the techniques described herein. In this example, the GUI 300 comprises an application bar 302 (also referred to herein as an “app bar”). The application bar 302 can be configured with a number of graphical elements, each associated with different functionality and/or content. For example, as illustrated, the graphical elements may be selectable by a user to provide access to content having a number of predetermined data types including, but not limited to, profile data, calendar data, email data, team forum data, chat forum data, file and/or document data, and any other data types accessible by a computing device. The selectable graphical elements can each provide access to files having data types and/or a category of functionality, such as a calendar program, email program, team forum program, chat forum program, image program, video program, document program, and other programs.

For illustrative purposes, profile data can include a user's name, a user representation, a user ID, phone number, or any other information associated with the user. The profile data can be accessed and displayed in response to a user selection of the first (“Profile”) graphical element. Calendar data can include a user's appointments stored in one or more calendar databases. The calendar data can be accessed and displayed in response to a user selection of the second (“Calendar”) graphical element. Email data can include a user's email messages and tasks stored in one or more email databases. The email data can be accessed and displayed in response to a user selection of the third (“Email”) graphical element. These examples of content data are provided for illustrative purposes and are not to be construed as limiting. It can be appreciated that other types of content data can be listed on the App bar 302 and made available for selection and display on the graphical user interface 300.

For illustrative purposes, a team can be defined by as a group of one or more specified users. In some configurations, a team includes a specified group of users that are invited to a team. In some implementations, data associated with the team, such as related messages and chat discussions, cannot be accessed by a user unless the user receives an invitation and accepts the invitation. For example, as illustrated, the user “Carol” has been invited to and has accepted membership in four teams, i.e. a “General” Team, a “Design” Team, a “Management” Team, and a “Product Test” Team. Once a user is invited to a team, that user can join one or more “channels” associated with the team. A channel, also referred to herein as a “channel forum,” can be defined by a custom group of users interested in a particular subject matter. For example, a team may have a “Shipping” channel, a “Development Schedule” channel, etc. In some implementations, the IM session 104 is provisioned in association with a channel forum to enable the users of that channel to communicate in real time by passing messages back and forth in real-time (e.g., with very little time delay, e.g., less than twenty seconds, less than five seconds, less than three seconds, less than one second, or substantially instantaneous). The system 102 may facilitate the IM session 104 by provisioning IM functionality to the users associated with a channel to enable them to share and view text, images and other data objects posted within a specific channel forum. The techniques disclosed herein can utilize channel communication data to provide the IM session 104 functionalities described herein.

A chat, also referred to as a “chat forum,” can include a specified group of users. In some configurations, users are only included in a chat by invitation. A chat session may exist between a group of users independent of their membership in a particular team and/or channel. Thus, a participant of a teleconference session can chat with users that are not members of a common team and that do not subscribe to a common channel. For example, a particular user may initiate a “chat” with one or more other users that are members of a common team with the particular user, are not members of a common team with the particular user, subscribe to a common channel with the particular user, and/or do not subscribe to a common channel with the particular user. Users associated with a chat forum can share and view text, images, and other data objects posted within a specific chat forum. The system 102 may facilitate the IM session 104 by provisioning IM functionality to the users associated with a “chat forum” to enable them to share and view text, images, and other data objects posted within a specific chat forum. The techniques disclosed herein can utilize “chat forum” communication data to provide the IM session 104 functionalities described herein.

As illustrated in FIG. 3, in various implementations, an aspect of a channel may provide users with IM session functionality associated with the channel. A channel may have one or more corresponding IM sessions 104 that enable users associated with the channel to transmit message content to other users associated with the channel in substantially real time. For example, as illustrated in FIG. 3, one or more users of the “Shipping” channel are actively participating in an IM session 104 in which messages may be transmitted back-and-forth in a conversational manner. In the illustrated example, a particular user (i.e., “Jeff”) of the “Shipping” channel has posted a message 304 in an active conversation (e.g., a conversation that one or more other users also have open on their respective client device(s)) of the IM session to which another user (i.e. “Sarah”) has posted a reply 306. Furthermore, in accordance with the techniques described herein, the system 102 determine that two other users (i.e. “Bill” and “Jen”) are currently and contemporaneously or concurrently generating message content in reply to the message 304. For example, the system 102 may receive user input signals 122(A) from client devices being operated by each of the users “Bill” and “Jen” to generate message content 122(B) in reply to the message 304. For example, the user input signals 122(A) may indicate to the system 102 that each of the users “Bill” and “Jen” have selected a user input element 310 of the GUI 300 and/or have begun using an input device 128 of their respective client devices to generate a message within their respective user input elements 310. Accordingly, the system 102 may cause a particular area 308 of the GUI 300 to display user representations 312 associated with each of the users “Bill” and “Jen.” For example, the system may access profile data associated with each of the users “Bill” and “Jen” to obtain user representations corresponding to each of their user accounts. Then, the system 102 may cause the GUI 300 to display user representations for “Bill” and “Jen” along with an indication that they are typing such as, for example, the illustrated message that “Bill & Jen are typing” displayed in association with a typing activity indicator, e.g. the illustrated ellipses. In some configurations, along with the display of the display user representations 312, the GUI's disclosed herein can also include a text description of the user input activity. Such text may include a description such as “is typing,” “is drawing,” “is providing input,” “are typing,” “are drawing,” “are providing input,” etc.

Turning now to FIGS. 4A & 4B (collectively referred to as “FIG. 4”), a pictorial flow diagram shows an illustrative process 400 of the system 102 dynamically modifying graphical arrangements 402 (as illustrated, each graphical arrangement has a particular number of predefined graphical areas as indicated in a parenthetical) of user representations 312 that are being displayed in the particular area 308 (e.g., outlined by a dashed line perimeter) of the GUI 300 based upon user input signals 122(A) being received from various client devices 106. The process is described with reference to a series of times (i.e. T1-T8) each time having a system illustration on the left side of the page and the corresponding view of the area 308 being displayed on client device 106(1) at that particular time.

At time T1, the system 102 is facilitating an IM session 104 between three separate client devices respectively labeled 106(1), 106(2), and 106(3). Each of the three client devices 106 may be communicatively coupled to the system 102, e.g. via the network(s) 108. At time T1, neither of client devices 106(1), 106(2) nor 106(3) are being currently used by a participant to generate message content 122(B) in association with the IM session 104. For example, these client devices' respective input device(s) 128 are not being used at time T1 to input message content 122(B) into respective user input elements 310 (not labeled on FIG. 4) being displayed at these devices. As shown in FIG. 4A, at time T2 a text description 403(1) of user input activity may indicate a sole user that is generating message content. For example, because at time T2 “Bill” is the only user typing, the text description 403(1) may state, for example, “Bill is typing.”

At time T2, a user of the client device 106(2) has begun actively generating message content in association with the IM session 104. Accordingly, the client module 120(2)(not shown on FIG. 4) of the client device 106(2) has begun to transmit a user input signal 122(A)(2) to the system 102. Upon receiving the user input signal 122(A)(2), the system 102 may access the profile data corresponding to a user account being used on the client device 106(2)(shown as 106(1) on FIG. 4). As illustrated, a user “Bill” is logged into the IM session 104 on the client device 106(2) and, therefore, the system may transmit IM data 138(1)^{-T2} (e.g., IM data 138 for client device 106(2) that is specific to Time T2 as indicated by the superscript) to the client device 106(2) to cause the GUI 300 to display a user representation 312(2) corresponding to the user “Bill.” The user representation 312(2) indicates to a user of the client device 106(2) that “Bill” is actively generating message content. As shown in FIG. 4A, at time T2 a text description 403(1) of user input activity may indicate a sole user that is generating message content. For example, because at time T2 “Bill” is the only user typing, the text description 403(1) may state, for example, “Bill is typing.”

At time T3, a user “Jen” of the client device 106(3) has also begun to actively generate message content in association with the IM session 104 contemporaneously or concurrently with the user “Bill.” Accordingly, the client module 120(3)(not shown on FIG. 4) of the client device 106(3) has also begun to transmit a user input signal 122(A)(3) to the system 102. Upon receiving the user input signal 122(A)(3) from the client device 106(3), the system 102 may access the profile data corresponding to a user account being used on the client device 106(3). As illustrated, a user “Jen” is logged into the IM session 104 on the client device 106(3) at time T3. In some implementations, the system 102 may deploy the user representation arrangement function 216 to determine a priority between the users corresponding to client devices 106(2) and 106(3). Then, based on the determined priority, the system 102 may determine a graphical arrangement of the user representation 312(3) corresponding to the user “Jen” with respect to the user representation 312(2) corresponding to the user “Bill.” In the illustrated example, “Bill” has priority over “Jen” due to having begun to generate message content prior to “Jen” and, therefore, the graphical arrangement 402(2) shows the user representation 312(2) in a dominant participant area (e.g. the left-most area of the graphical arrangement 402(2). As shown in FIG. 4A, at time T3 a text description 403(2) of user input activity may specifically indicate two users that are generating message content. For example, because at time T3 both “Bill” and “Jen” are generating message content, the text description 403(2) may state, for example, “Bill & Jen are typing.”

At time T4, a user “Sam” has logged into the IM session 104 from the client device 106(4) and has also begun to actively generate message content in association with the IM session 104 contemporaneously or concurrently with the users “Bill” and “Jen.” Accordingly, the client module 120(4) (not shown on FIG. 4) of the client device 106(4) has also begun to transmit a user input signal 122(A)(4) (shown as 122(A)(3) on figure) to the system 102. Upon receiving the user input signal 122(A)(4) from the client device 106(4), the system 102 may determine that all of “Bill,” “Jen,” and “Sam,” are concurrently generating message content in association with the IM session 104. Accordingly, the system 102 may determine a priority between “Bill,” “Jen,” and “Sam.” Then, based on the determined priority, the system 102 may determine a graphical arrangement 402(3) to cause the client device 106(1) to display “Bill,” “Jen,” and “Sam's” respective user representations at time T4. Then, the system 102 may transmit IM data 138(1)T⁴ to the client device 106(1) to cause the GUI 300 of the computing device 106(1) to display the graphical arrangement 402(3) within the area 308 to indicate to a user of the client device 106(1) that all of “Bill,” “Jen,” and “Sam” are concurrently generating message content in association with the IM session 104 and the priority between them. As shown in FIG. 4A, at time T4 a text description 403(3) of user input activity may specifically indicate three users that are generating message content. For example, as illustrated, the text description 403(3) may state, for example, “Bill, Jen, & Sam are typing.”

At time T5 on FIG. 4B, a user “Bob” has logged into the IM session 104 from the client device 106(5) and has also begun to actively generate message content in association with the IM session 104 contemporaneously or concurrently with all of “Bill,” “Jen,” and “Sam.” Again, the system 102 may determine a priority among these users and then based on the determined priority determine a graphical arrangement such as, for example, the graphical arrangement 402(4) to cause the client device 106(1) to display the graphical arrangement at time T5. Then, the system 102 may transmit IM data 138(1)^{T5} to the client device 106(1) to cause the GUI 300 of the computing device 106(1) to display the graphical arrangement 402(4) within the area 308 to indicate to a user of the client device 106(1) that all of “Bill,” “Jen,” “Sam,” and “Bob” are all concurrently generating message content in association with the IM session 104. As shown in FIG. 4B, at time T5 a text description 403(4) of user input activity may specifically indicate a specific number of users (e.g. four users, five users, six users, and so on) that are generating message content.

The graphical arrangements 402(1) through 402(4) illustrate various exemplary user representation grids. As illustrated, these user representation grids are defined by a substantially circular outer perimeter (that may be partially truncated to give the appearance of “peeking” over the user input element 310) that defines an interior grid having a number of predetermined areas that corresponds to a number of users that are concurrently typing. In particular, because at time T2 only a single user is generating message content, the graphical arrangement 402(1) has only a single predefined graphical area bound by the substantially circular outer perimeter. Because at time T3 two users are generating message content concurrently, the graphical arrangement 402(2) includes two predefined graphical areas bound by the substantially circular outer perimeter. Furthermore, the graphical arrangement 402(2) has a dominant participant area on the left-hand side to indicate to the user of the client device 106(1) which one of the users “Bill” and “Jen” began typing first. It can be appreciated that although the various graphical arrangements 402 illustrated in FIGS. 4A-4B include up to four predefined graphical areas, in various other examples more or less predefined graphical areas may also be used. Furthermore, although the user representation grids are shown as being substantially circular, in various instances the user representation grids may be square, rectangular, oval, or any other suitable shape or combination of shapes.

At time T6, the system has determined that at least a threshold number of users are concurrently generating message content 122(B) in association with the IM session 104. In the illustrated example, the system 102 is receiving user input signals 122(A) from five or more separate client devices 106. Accordingly, to reduce visual clutter that may occur if numerous user representations are displayed, the system 102 may transmit IM data 138(1)^{T6} to the client device 106(1) to cause the GUI 300 of the computing device 106(1) to display a generic group of user representations 404 (also referred to herein as a “group-of-users representation 404”) to indicate that numerous users are concurrently generating message content. In the illustrated implementation, the GUI 300 is also caused to indicate precisely how many users are concurrently generating message content. In particular, as illustrated, the GUI 300 is displaying the generic group of user representations 404 along with a text description 403(5) stating that “8 people are typing.” It can be appreciated that the text description 403 need not indicate specific user names but rather, in some instances, may indicate simply a specific number of users that are generating message content, that at least one user is generating message content, that a group of users is generating message content, etc.

At time T7, the system 102 is no longer receiving user input signals 122(A) from several of the devices that were participating at time T6. Specifically, at time T7 the system determines that only “Jen,” “Sam,” and “Bob” are still concurrently generating message content 122(B) in association with the IM session 104 (although “Bill's” client device 106(2) is still connected to the system, “Bill” has stopped generating message content). Accordingly, the system 102 may transmit IM data 138(1)^{T7} to the client device 106(1) to cause the GUI 300 of the computing device 106(1) to once again display the graphical arrangement 402(3) having three predefined graphical areas. Furthermore, because “Bill” is no longer typing at time T7, the graphical arrangement 402(3) has different users assigned to its particular predefined graphical areas as compared to those that were assigned at time T5. In particular, because “Jen” is now the first to have begun generating the message content (i.e. compared to “Sam” and “Bob”), the system 102 has assigned the user representation 312(3) corresponding to “Jen” to the dominant participant area of the graphical arrangement 402(3).

In some implementations, the system 102 causing the client device 106(1) to no longer render the user representation of “Bill” is further based on user engagement data indicating an engagement level of “Bill” with respect to the IM session 104. For example, even though the system 102 is no longer receiving the user input signal 122(A)(2) from “Bill's” client device 106(2), one or both of the system 102 and/or the client device 106(2) may access one or more sensors of the client device 106(2) to determine whether “Bill” is still actively engaged in the IM session 104 despite having paused his generation of message content 122(B). It can be appreciated that in certain circumstances a user may wish to carefully word a message prior to transmitting the message into the IM session 104. Accordingly, it can be appreciated that even if a user is not actively entering characters or other digital data structures into a user input field of a GUI on his or her respective device, he or she may still be actively generating message content—albeit mentally. Accordingly, in some implementations, when a user stops actively typing or otherwise entering digital message content into a user input field associated with the IM session 104, the system 102 and/or that particular device 106 may determine user engagement data associated with whether that user is likely to be still actively mentally engaged with the IM session 104.

As a more specific but nonlimiting example, suppose a user transcribes a lengthy message (e.g., several long paragraphs) and upon finishing typing this lengthy message into a user input field of the IM session the user begins to proofread the message before hitting a “send” button. Under these circumstances, this user's client device may determine that the user has stopped actively typing message content and, based thereon may access a camera to capture image data of the user. Then, based on the image data, the system and/or the client device may determine whether the user's focus remains on the recently generated message content such that the user may be considered to still be “actively generating” the message content. For example, the system 102 may analyze the image data to determine an eye gaze direction of the user and, ultimately, to determine whether the user's eye gaze remains directed toward message content that the user has yet to transmit.

At time T8, the system 102 is again receiving user input signals 122(A) from at least the threshold number of client devices 106. Therefore, the IM data 138(1)^{T8} transmitted from the system 102 to the client device 106(1) again causes the GUI 300 of the client device 106(1) to display the generic group of user representations 404. Additionally, at time T8, the system has begun receiving a user input signal 122(A)(CEO) from a particular computing device 106(CEO) that corresponds to a user that the user representation arrangement function 216 recognizes as relatively important as compared to other users within the IM session 104 (e.g., due to being indicated as being the CEO of a business within an organizational chart to which the system 102 has access). Accordingly, in some implementations, the IM data 138(1)T⁸ may further cause the GUI 300 of the client device 106(1) to prominently display a user representation 312(CEO) corresponding to important user (e.g. “Sally Smith”) to inform the other participants of the IM session 104 that “Sally Smith” is both present and also actively typing a message to the other participants of the IM session 104. As shown in FIG. 4B, at time T5 a text description 403(6) of user input activity may specifically indicate when a particularly important user is generating message content apart from indicating whether other users are generating message content and/or how many other users are generating message content and/or who other users are that are generating message content.

Turning now to FIG. 5, a pictorial flow diagram shows an illustrative process 500 of the system 102 dynamically modifying graphical arrangements 502 of user representations 312 that are being displayed in the particular area 308 of the GUI 300 based upon user input signals 122(A) being received from various client devices 106. As illustrated, each graphical arrangement 502 includes a particular number of user representations 312 as indicated in a parenthetical. The process 500 is described with reference to the series of times as discussed with relation to FIGS. 4A and 4B. In particular, the system illustrations on the left side of the pages of FIGS. 4A and 4B apply equally to FIG. 5 where the same time is used (T8 appears only in FIG. 4B).

In the example illustrated in FIG. 5, a user representation 312 corresponding to the highest priority user that is currently generating message content is illustrated in the leftmost position (which may also be referred to as the dominant participant area) of the respective graphical arrangement 502. In arrangements where more than one user representation 312 is shown, the representations are ordered from left to right according to their priority status. For example, the second highest priority user will be in the second leftmost position, the third highest priority user will be in the third leftmost position, etc. In some implementations, as individual users stop generating message content 122(B), their respective user representation may be animated out of the current graphical arrangement and any lesser priority users may be shifted to the left to backfill the empty dominance position.

At time T1, no participants of the IM session 104 are actively generating message content 122(B) and, accordingly, the system 102 does not instruct the client device 106(1) to display any user representation 312 in association with a typing activity indicator.

At time T2, the user “Bill” has begun generating message content 122(B) using the client device 106(2)(not shown in FIG. 5) and, accordingly, the system 102 instructs the client device 106(1) to display the user representation 312(2) that is associated with the user “Bill” in the graphical arrangement 502(1).

At time T3, the user “Jen” has begun generating message content 122(B) concurrently with the user “Bill” and, accordingly, the system 102 instructs the client device 106(1) to display the user representation 312(3)(not labeled) that is associated with the user “Jen” in the second leftmost position of the graphical arrangement 502(2).

At each of time T4 through T6, one or more additional users begin generating message content in association with the IM session 104 and, accordingly, the system 102 instructs the client device 106(1) to display corresponding user representations 312 (not labeled) in a graphical arrangement 502 that corresponds to the number of users that are typing. In some implementations, the system 102 may be configured to refrain from instructing the client device 106(1) from displaying additional user representations past a particular threshold number. For example, the system 102 may be configured to display no more than six user representations, no more than eight user representations, no more than ten user representations, or any other suitable number selected based on design parameters.

At time T7, numerous users including the user “Bill” have stopped generating message content in association with the IM session 104. In particular, the system 102 has determined that only the users “Jen,” “Sam,” and “Bob” are still concurrently generating message content 122(B) in association with the IM session 104 and, accordingly, the system 102 instructs the client device 106(1) to again display the graphical arrangement 502(3) but this time with the user representation for Jen in the leftmost position, the user representation for “Sam” in the second to leftmost position, and finally the user representation for “Bob” in the last position in terms of priority between these users.

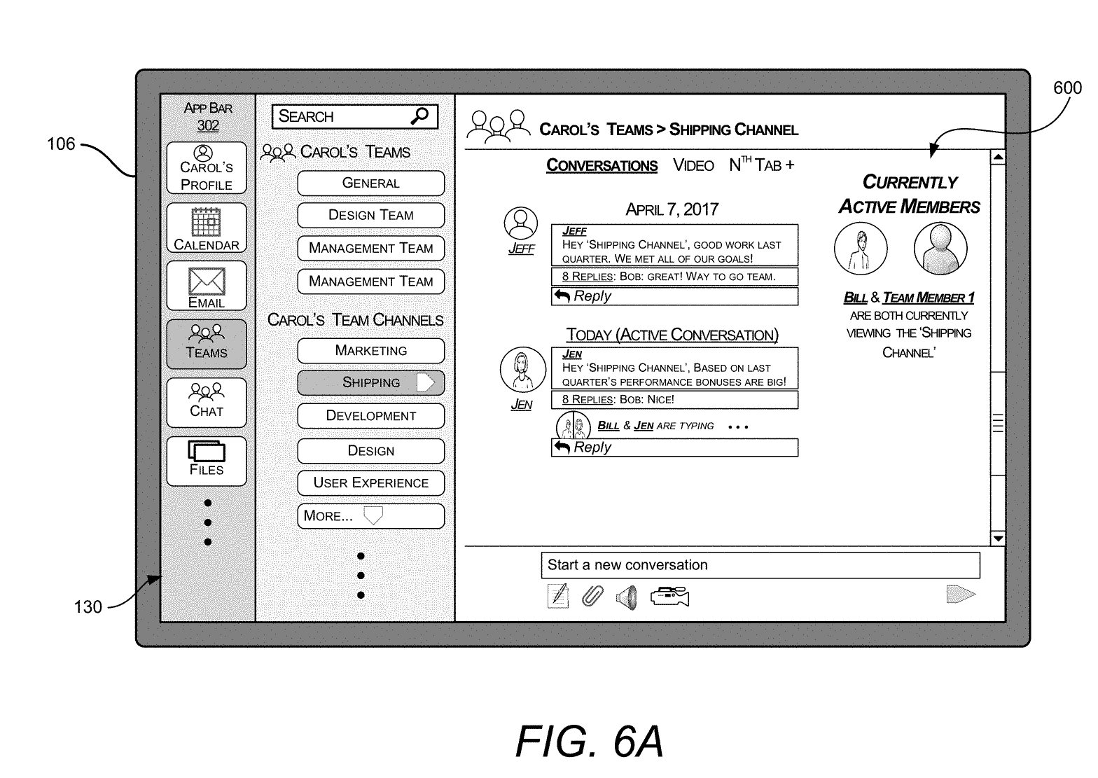

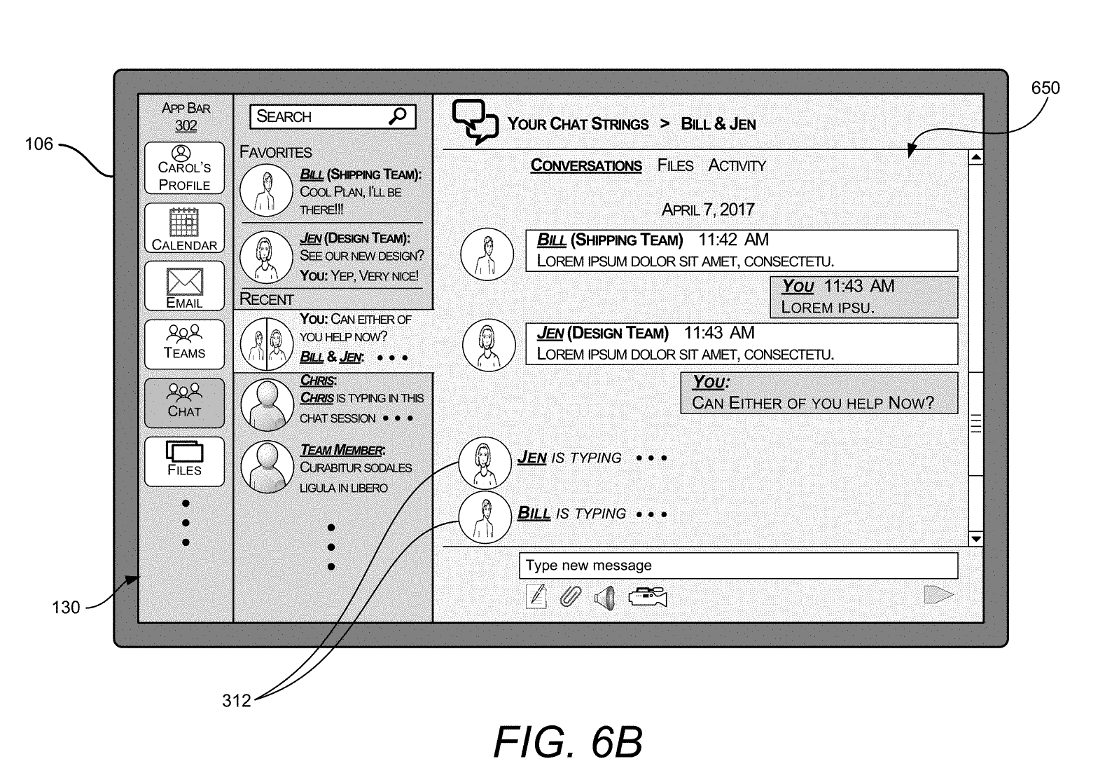

Turning now to FIGS. 6A and 6B, various additional aspects are illustrated of a GUI that can be displayed on a client computing device 106 during an IM session 104 in accordance with the techniques described herein.

With particular reference to FIG. 6A, in various implementations, a GUI 600 (shown as spanning the entire display area of the display 130) can be displayed on a display 130 of a client device 106 during an IM session 104 to indicate one or more users that are currently active within the IM session 104. For example, as illustrated, the GUI 600 is indicating that both of the users “Bill” and “Team Member 1” are currently active within an active IM session 104 corresponding to the “Shipping” channel. In some implementations, the client modules 120 associated with the individual client devices 106 may be configured to transmit a signal to the system 102 indicating when a display 130 is currently rendering a GUI associated with the illustrated “Shipping” channel in the IM session 104. Accordingly, in various implementations participants of an IM session 104 may be informed not only of when one or more other users are actively generating message content 122(B) but also when one or more other users are simply viewing messages associated with the IM session 104 via a GUI.

With particular reference to FIG. 6B, in various implementations, a GUI 650 is shown to illustrate that the IM session 104 may be facilitated by the system 102 to provide users associated with a “chat forum” with an ability to share and view text, images, and other data objects posted within a specified chat forum. As illustrated, in various implementations a graphical arrangement of user representations 312 may “stack” the user representations vertically according to a priority. For example, as illustrated, both of the users “Bill” and “Jen” are concurrently typing. However, based on the graphical arrangement of their user representations 312 it may be understood that “Bill” began typing prior to “Jen.”

In some implementations, the system 102 may be configured to cause a client device 106 to indicate when one or more users are generating message content in association with an IM session 104 that is not currently selected for viewing on the client device 106. For example, as illustrated in FIG. 6B, the GUI 650 illustrates that a chat session between a user of the illustrated client device 106 has selected a chat session between herself and both of the users “Bill” and “Jen.” The GUI 650 is shown to communicate to the user that “Bill” and “Jen” are currently typing in the chat session that is selected, and furthermore that “Chris” is currently typing in a different chat session that the user has not selected for immediate viewing.

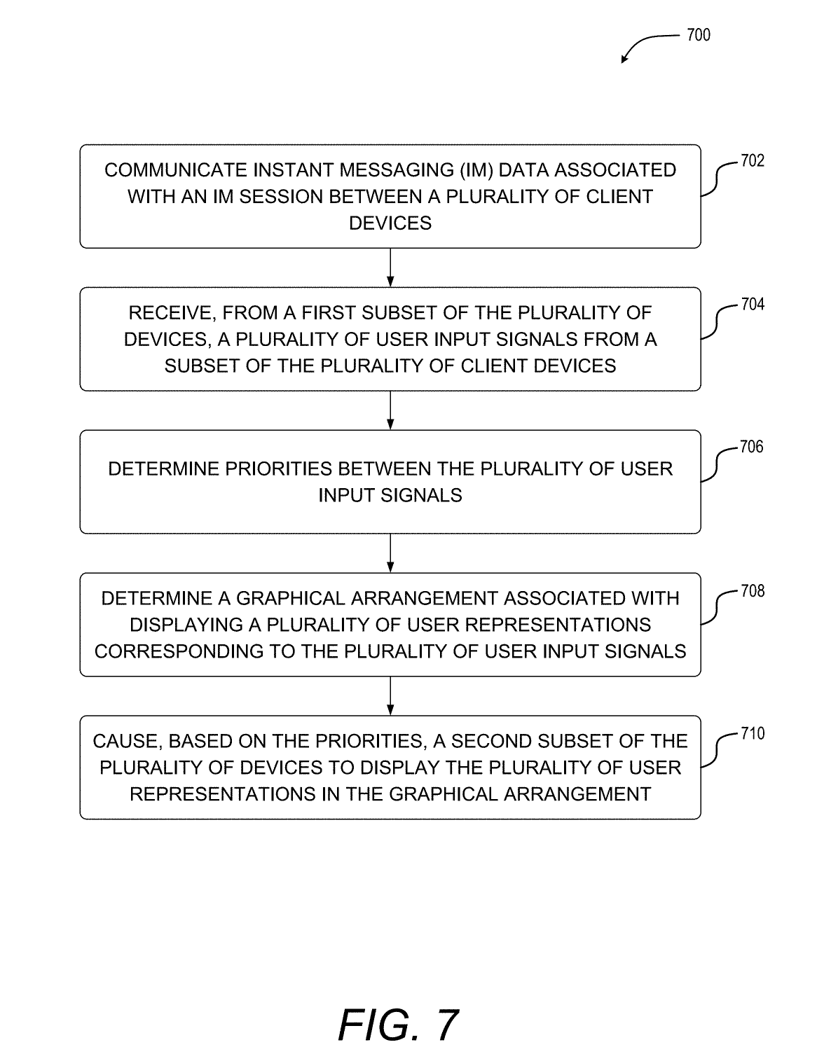

Turning now to FIG. 7, a flow diagram is illustrated of a process 700 for modifying graphical arrangements of user representations based upon user input signals 122 being received from different client computing devices 106. The process 700 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform or implement particular functions. The order in which operations are described is not intended to be construed as a limitation, and any number of the described blocks can be combined in any order and/or in parallel to implement the process. Other processes described throughout this disclosure shall be interpreted accordingly.

At block 702, the system 102 communicates instant message (IM) data associated with an IM session between a plurality of client devices 106 for the purpose of facilitating an IM session 104 as discussed herein. Communicating the IM data may include receiving user input data 122 at a server module 132 and processing the user input data 122 to generate the IM data 138. Ultimately, an output module 136 may transmit instances of the IM data 138 to individual ones of the client devices 106.

At block 704, the system 102 may receive a plurality of user input signals from a first subset of the plurality of client devices 106. Generally speaking a subset of the plurality of devices may include a single client device or a plurality of client devices. However, with respect to block 704, for purposes of the present discussion the first subset of the plurality of devices 106 includes two or more client devices such that a user input signal is received from at least two client devices 106. In some instances, the first subset includes all of the client devices 106 currently participating in the IM session 104. Stated alternatively, in various implementations the system 102 may be receiving user input signals from each of the client computing devices 106(1) through 106(N) indicating that all participants of the IM session 104 are contemporaneously or concurrently generating message content 122(B). In other implementations, the system may be receiving user input signals from less than all of the client devices 106, e.g. when not all participants are contemporaneously or concurrently generating message content.

In some implementations, one or more user input signals received from the first subset of the plurality of client devices 106 may be generated in response to a voice input from a participant of the IM session 104. For example, a participant of the IM session 104 may be using one or more microphones to generate message content with respect to the IM session 104. As a more specific but nonlimiting example, in some implementations a participants may dictate message content with respect to the IM session 104 via a microphone used in conjunction with speech recognition software. In some implementations, a user input signal may correspond to activating and/or deactivating a button associated with a microphone. For example, a participant of the IM session 104 may be wearing a headset that is operably coupled to a button that is configured to activate and/or deactivate the microphone with respect to the IM session 104.

In some implementations, one or more user input signals received from the first subset of the plurality of client devices 106 may be generated in response to a stylus input onto one or more touch sensitive surfaces (e.g. a touch sensitive display surface) that is operably coupled to at least one of the plurality of client devices 106. For example, a participant of the IM session 104 may generate message content by using a stylus pen to physically write out the message content on the one or more touch sensitive surfaces.

At block 706, the system 102 may determine priorities between the plurality of user input signals 122 based on some objectively measurable characteristic such as, for example, an order in which the plurality of user input signals were received and/or a status associated with the user accounts from which the plurality of user input signals originated. In some implementations, the priority may be determined based on a single factor. For example, the priority may be determined solely on a first-to-type basis such that the priority between the plurality of user input signals corresponds directly to the order in which the user input signals were initially received. In some implementations, the first signal to be received may be afforded the highest priority whereas in other implementations the last signal to be received may be afforded the highest priority. In some implementations, the priority may be determined based on a non-temporal based single factor such as, for example, a user's status within an organizational hierarchy and/or a user's contribution level towards the IM session 104. For example, in some implementations, the system 102 may track a relative amount of contributions into the IM session 104 on a per participant basis and, ultimately, determine the priority at least in part on the relative amount of contributions into the IM session 104 that a particular participant has submitted in relation to the other participants. In some implementations, the system 102 may determine priorities between the plurality of user input signals based on a combination of multiple factors. For example, with particular reference to T8 of FIG. 4B, it can be appreciated that although “Jen” began typing prior to “Sally Smith” the system 102 factored “Sally Smith's” status as the business's CEO into its determination of priorities between the various users.

At block 708, the system 102 may determine a graphical arrangement associated with displaying a plurality of user representations that correspond to the plurality of user input signals. For example, the system 102 may determine how many users are contemporaneously or concurrently typing based on how many user input signals are contemporaneously or concurrently being received. Then, the system may determine how to arrange this number of user representations within a GUI displayed on a client device 106 and, ultimately, assign individual user representations associated with the individual user input signals into one or more predetermined areas of the determined graphical arrangement.

At block 710, the system may cause a second subset of the plurality of client devices to display a plurality of user representations corresponding to the plurality of user input signals to indicate which users are contemporaneously or concurrently generating message content 122(B). Furthermore, the plurality of user representations made be displayed according to the graphical arrangement determined at block 708 to communicate the relative priority of each user that is currently typing with respect to each other user that is currently typing. It should be appreciated that the first subset of the plurality of client devices may overlap with the second subset of the plurality of client devices. For example, in an instance where each of users “A” and “B” are both contemporaneously or concurrently typing, the system 102 may cause devices other than those being used by users “A” and “B” to indicate that both “A” and “B” are currently typing, and may also cause the device being operated by user “A” to indicate that user “B” is currently typing, and vice versa. Accordingly, it can be appreciated that the devices being operated by users “A” and “B” are each included within both the first subset and the second subset whereas the other devices are included in only the second subset. In particular, these devices are not transmitting user input signals 122(A) to the system 102 but the system does cause them to display user representations to indicate who is currently typing.

### Example Clauses

The disclosure presented herein may be considered in view of the following clauses.

Example Clause A, a system, comprising: one or more processing units; and a computer-readable medium having encoded thereon computer-executable instructions to cause the one or more processing units to: communicate instant messaging (IM) data associated with an IM session between a plurality of client devices, the plurality of client devices including at least a first client device associated with a first user account, a second client device associated with a second user account, and a third client device associated with a third user account; receive, from the first client device, a first user input signal indicating that first message content is being generated through the second user account in association with the IM session; receive, from the second client device, a second user input signal indicating that second message content is being generated through the third user account in association with the IM session; and in response to the first user input signal and the second user input signal, cause a display of the third client device to simultaneously render a first user representation associated with the first user account and a second user representation associated with the second user account on a graphical user interface to indicate that the first message content is being generated through the first user account concurrently with the second message content being generated through the second user account.

Example Clause B, the system of Example Clause A, wherein the computer-executable instructions further cause the one or more processing units to determine a graphical arrangement of the second user representation with respect to the first user representation based at least in part on the second user input signal being received subsequent to the first user input signal.

Example Clause C, the system of any one of Example Clauses A through B, wherein the computer-executable instructions further cause the one or more processing units to determine at least one organizational status associated with at least one of the first user account or the second user account, wherein the graphical arrangement of the second user representation with respect to the first user representation is based at least in part on the at least one organizational status.

Example Clause D, the system of any one of Example Clauses A through C, wherein the computer-executable instructions further cause the one or more processing units to: based on a determination that a participant of the IM session has stopped generating the first message content in association with the first user account, cause the display to animate a transition from a first graphical arrangement that includes both the first user representation and the second user representation to a second graphical arrangement that includes the second user representation and omits the first user representation.

Example Clause E, the system of any one of Example Clauses A through D, wherein the computer-executable instructions further cause the one or more processing units to cause the display to render a generic group-of-users representation based on a determination that message content is being generated concurrently in association with at least a threshold number of user accounts, wherein a rendering of the generic group-of-users representation replaces at least a rendering of the first user representation and a rendering of the second user representation.

Example Clause F, the system of any one of Example Clauses A through E, wherein the computer-executable instructions further cause the one or more processing units to: receive user engagement data corresponding to a participant that is associated with a particular user account, wherein the user engagement data indicates an engagement level of the participant with respect to the IM session; and cause, based at least in part on the engagement level of the participant, the display of the first client device to transition from rendering a first graphical arrangement to rendering a second graphical arrangement, wherein the first graphical arrangement includes a particular user representation that corresponds to the particular user account, and wherein the second graphical arrangement omits the particular user representation.

Example Clause G, the system of any one of Example Clauses A through F, wherein the user engagement data includes an indication of at least one of: an absence of user input activity at the particular client device associated with the particular user account for at least a threshold amount of time; or an eye gaze of the participant being directed away from a particular graphical user interface associated with the IM session.

While Example Clauses A through G are described above with respect to a system, it is understood in the context of this document that the subject matter of Example Clauses A through G can also be implemented by a device, via a computer-implemented method, and/or via computer-readable storage media.

Example Clause H, a computer-implemented method, comprising: receiving, at a first client device, instant messaging (IM) data associated with an IM session that is being hosted with respect to a plurality of user accounts, the plurality of user accounts including at least: a first user account associated with a first user representation, a second user account associated with a second user representation, and a third user account associated with a third user representation; causing, based on the IM data, a display of the first client device to render a first graphical user interface (GUI) corresponding to the first user account; receiving, at the first client device, an indication that first message content is being generated at a second client device through a second GUI corresponding to the second user account concurrently with second message content being generated at a third client device through a third GUI corresponding to the third user account; and causing, based at least in part on the indication, the display to modify the first GUI to simultaneously render both the second user representation and the third user representation in association with at least one typing activity indicator.

Example Clause I, the computer-implemented method of Example Clause H, further comprising: receiving, at the first client device, a second indication that a participant of the instant messaging session has stopped generating the first message content at the second client device; and causing, based on the second indication, the display to stop rendering the second user representation in association with the at least one typing activity indicator while continuing to render the third user representation in association with the at least one typing activity indicator.

Example Clause J, the computer-implemented method of any one of Example Clauses H through I, wherein the second user representation is positioned with respect to a user input element of the first GUI, and wherein the third user representation is positioned with respect to the second user representation based at least in part on a priority of the second user account with respect to the third user account.

Example Clause K, the computer-implemented method of any one of Example Clauses H through J, wherein the second user account has a priority over the third user account based on a first user input signal being initiated by the second client device prior to a second user input signal being initiated by the third client device.

Example Clause L, the computer-implemented method of any one of Example Clauses H through K, wherein the second user representation is assigned to a predetermined dominant participant area of the first GUI based at least in part on the priority of the second user account with respect to the third user account.

Example Clause M, the computer-implemented method of any one of Example Clauses H through L, further comprising assigning the third user representation to the predetermined dominant participant area of the first GUI based on an absence of a first user input signal being generated by the second client device for at least a threshold time period.

Example Clause N, the computer-implemented method of any one of Example Clauses H through M, wherein the second user representation is rendered larger than the third user representation based at least in part on the second user representation being assigned to the predetermined dominant participant area.

Example Clause O, the computer-implemented method of any one of Example Clauses H through N, wherein the at least one typing activity indicator includes at least one graphical element that is determined based at least in part on a user representation arrangement function associated with assigning the second user representation to one or more individual quadrants of the at least one graphical element based on a priority of the second user account with respect to the third user account.

While Example Clauses H through O are described above with respect to a method, it is understood in the context of this document that the subject matter of Example Clauses H through O can also be implemented by a device, by a system, and/or via computer-readable storage media.

Example Clause P, a system, comprising: one or more processing units; and a computer-readable medium having encoded thereon computer-executable instructions to cause the one or more processing units to: communicate instant messaging (IM) data associated with an IM session between a plurality of client devices; receive, from a first subset of the plurality of client devices, a plurality of user input signals, wherein individual user input signals of the plurality of user input signals are initially received at a plurality of different times; determine, based at least in part on the plurality of different times, at least one priority between at least a particular user input signal, of the plurality of user input signals, and other user input signals of the plurality of user input signals; determine a graphical arrangement associated with displaying a plurality of user representations corresponding to the plurality of user input signals, wherein the graphical arrangement is based at least in part on a size of the first subset; and cause, based at least in part on the at least one priority, a second subset of the plurality of devices to display the plurality of user representations in the graphical arrangement.

Example Clause Q, the system of Example Clause P, wherein the graphical arrangement is a user representation grid comprising a plurality of predetermined graphical areas, and wherein individual user representations of the plurality of user representations are assigned to individual predetermined graphical areas of the plurality of predetermined graphical areas based on the at least one priority.

Example Clause R, the system of any one of Example Clauses P through Q, wherein the computer-executable instructions further cause the one or more processing units to cause, based on a termination of a particular user input signal, the second subset of the plurality of client devices to animate out a particular user representation associated with the particular user input signal.

Example Clause S, the system of any one of Example Clauses P through R, wherein the at least one priority is further based on at least one of: an organizational status of a particular user corresponding to a particular user input signal of the plurality of user input signals; or a contribution level toward the IM session of the particular user corresponding to the particular user input signal.

Example Clause T, the system of any one of Example Clauses P through S, wherein the second subset of the plurality of client devices is caused to display individual user representations of the plurality of user representations based on the individual user input signals lasting for at least a threshold period of time.

While Example Clauses P through T are described above with respect to a system, it is understood in the context of this document that the subject matter of Example Clauses P through T can also be implemented by a device, via a computer-implemented method, and/or via computer-readable storage media.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A system, comprising:
one or more processing units; and
a computer-readable medium having encoded thereon computer-executable instructions to cause the one or more processing units to:
communicate instant messaging (IM) data associated with an IM session between a plurality of client devices, the plurality of client devices including at least a first client device associated with a first user account, a second client device associated with a second user account, and a third client device associated with a third user account;
receive, from the first client device, a first user input signal indicating that first message content is being generated through the second user account in association with the IM session;
receive, from the second client device, a second user input signal indicating that second message content is being generated through the third user account in association with the IM session; and
in response to the first user input signal and the second user input signal, cause a display of the third client device to simultaneously render a first user representation associated with the first user account and a second user representation associated with the second user account on a graphical user interface to indicate that the first message content is being generated through the first user account concurrently with the second message content being generated through the second user account.

2. The system of claim 1, wherein the computer-executable instructions further cause the one or more processing units to determine a graphical arrangement of the second user representation with respect to the first user representation based at least in part on the second user input signal being received subsequent to the first user input signal.

3. The system of claim 2, wherein the computer-executable instructions further cause the one or more processing units to determine at least one organizational status associated with at least one of the first user account or the second user account, wherein the graphical arrangement of the second user representation with respect to the first user representation is based at least in part on the at least one organizational status.

4. The system of claim 1, wherein the computer-executable instructions further cause the one or more processing units to:
based on a determination that a participant of the IM session has stopped generating the first message content in association with the first user account, cause the display to animate a transition from a first graphical arrangement that includes both the first user representation and the second user representation to a second graphical arrangement that includes the second user representation and omits the first user representation.

5. The system of claim 1, wherein the computer-executable instructions further cause the one or more processing units to cause the display to render a generic group-of-users representation based on a determination that message content is being generated concurrently in association with at least a threshold number of user accounts, wherein a rendering of the generic group-of-users representation replaces at least a rendering of the first user representation and a rendering of the second user representation.

6. The system of claim 1, wherein the computer-executable instructions further cause the one or more processing units to:
receive user engagement data corresponding to a participant that is associated with a particular user account, wherein the user engagement data indicates an engagement level of the participant with respect to the IM session; and
cause, based at least in part on the engagement level of the participant, the display of the first client device to transition from rendering a first graphical arrangement to rendering a second graphical arrangement, wherein the first graphical arrangement includes a particular user representation that corresponds to the particular user account, and wherein the second graphical arrangement omits the particular user representation.

7. The system of claim 6, wherein the user engagement data includes an indication of at least one of: an absence of user input activity at the particular client device associated with the particular user account for at least a threshold amount of time; or an eye gaze of the participant being directed away from a particular graphical user interface associated with the IM session.

8. A computer-implemented method, comprising:
receiving, at a first client device, instant messaging (IM) data associated with an IM session that is being hosted with respect to a plurality of user accounts, the plurality of user accounts including at least:
a first user account associated with a first user representation,
a second user account associated with a second user representation, and
a third user account associated with a third user representation;
causing, based on the IM data, a display of the first client device to render a first graphical user interface (GUI) corresponding to the first user account;
receiving, at the first client device, an indication that first message content is being generated at a second client device through a second GUI corresponding to the second user account concurrently with second message content being generated at a third client device through a third GUI corresponding to the third user account; and
causing, based at least in part on the indication, the display to modify the first GUI to simultaneously render both the second user representation and the third user representation in association with at least one typing activity indicator.

9. The computer-implemented method of claim 8, further comprising:
receiving, at the first client device, a second indication that a participant of the instant messaging session has stopped generating the first message content at the second client device; and
causing, based on the second indication, the display to stop rendering the second user representation in association with the at least one typing activity indicator while continuing to render the third user representation in association with the at least one typing activity indicator.

10. The computer-implemented method of claim 8, wherein the second user representation is positioned with respect to a user input element of the first GUI, and wherein the third user representation is positioned with respect to the second user representation based at least in part on a priority of the second user account with respect to the third user account.

11. The computer-implemented method of claim 8, wherein the second user account has a priority over the third user account based on a first user input signal being initiated by the second client device prior to a second user input signal being initiated by the third client device.

12. The computer-implemented method of claim 11, wherein the second user representation is assigned to a predetermined dominant participant area of the first GUI based at least in part on the priority of the second user account with respect to the third user account.

13. The computer-implemented method of claim 12, further comprising assigning the third user representation to the predetermined dominant participant area of the first GUI based on an absence of a first user input signal being generated by the second client device for at least a threshold time period.

14. The computer-implemented method of claim 12, wherein the second user representation is rendered larger than the third user representation based at least in part on the second user representation being assigned to the predetermined dominant participant area.

15. The computer-implemented method of claim 8, wherein the at least one typing activity indicator includes at least one graphical element that is determined based at least in part on a user representation arrangement function associated with assigning the second user representation to one or more individual quadrants of the at least one graphical element based on a priority of the second user account with respect to the third user account.

16. A system, comprising:
one or more processing units; and
a computer-readable medium having encoded thereon computer-executable instructions to cause the one or more processing units to:
communicate instant messaging (IM) data associated with an IM session between a plurality of client devices;
receive, from a first subset of the plurality of client devices, a plurality of user input signals, wherein individual user input signals of the plurality of user input signals are initially received at a plurality of different times;
determine, based at least in part on the plurality of different times, at least one priority between at least a particular user input signal, of the plurality of user input signals, and other user input signals of the plurality of user input signals;
determine a graphical arrangement associated with displaying a plurality of user representations corresponding to the plurality of user input signals, wherein the graphical arrangement is based at least in part on a size of the first subset; and
cause, based at least in part on the at least one priority, a second subset of the plurality of devices to display the plurality of user representations in the graphical arrangement.

17. The system of claim 16, wherein the graphical arrangement is a user representation grid comprising a plurality of predetermined graphical areas, and wherein individual user representations of the plurality of user representations are assigned to individual predetermined graphical areas of the plurality of predetermined graphical areas based on the at least one priority.

18. The system of claim 16, wherein the computer-executable instructions further cause the one or more processing units to cause, based on a termination of a particular user input signal, the second subset of the plurality of client devices to animate out a particular user representation associated with the particular user input signal.

19. The system of claim 16, wherein the at least one priority is further based on at least one of: an organizational status of a particular user corresponding to a particular user input signal of the plurality of user input signals; or a contribution level toward the IM session of the particular user corresponding to the particular user input signal.

20. The system of claim 16, wherein the second subset of the plurality of client devices is caused to display individual user representations of the plurality of user representations based on the individual user input signals lasting for at least a threshold period of time.
